(19) United States
(12) Patent Application Publication
(10) Pub. No.: US 2004/0232854 A1
(43) Pub. Date: Nov. 25, 2004

(54) BACKLIGHT SOURCE

(76) Inventor: Hui-Kai Chou, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/707,275

(22) Filed: Dec. 2, 2003

(30) Foreign Application Priority Data
May 23, 2003 (TW) 092114009

(51) Int. Cl. H05B 37/02

(52) U.S. Cl. 315/291; 349/58

(57) ABSTRACT

A backlight source disposed under a display panel includes a plurality of parallel U-shaped lamps. Each of the U-shaped lamps has a high voltage electrode and a low voltage electrode. The high voltage electrodes of the U-shaped lamps are disposed equally on two sides of the display panel.

### BACKGROUND OF INVENTION

1. Field of the Invention

The present invention relates to a direct-type backlight unit, and more specifically, to a backlight source employed in the backlight unit.

2. Description of the Prior Art

Backlight units are known in the art. The backlight unit, which is a key element in the fabrication of liquid crystal displays (LCDs), is widely used in monitors, notebooks, digital cameras, projectors and so on. Backlight units are typically divided into two major categories: edge light type and direct-type, wherein the direct-type backlight unit can provide higher intensity of light by utilizing a plurality of lamps and is thus more suited for large size display panels, such as display panels or TV panels, than the edge light type.

Referring to FIG. 1, it is a schematic view of a backlight source 10 of a backlight unit according to the prior art. As shown in FIG. 1, the backlight source 10 is disposed in a bezel 12 under a display panel (not shown) and comprises a plurality of straight lamps 14 parallel arranged in the bezel 12, and a control circuit (not shown in FIG. 1) for respectively driving each corresponding straight lamp 14 to emit light. Normally, the display panel is a LCD panel, the bezel 12 comprises either a plastic shield, an aluminum bezel or a metal plate, and the straight lamp 14 is a cold cathode fluorescent lamp (CCFL),which emits visible light by the ultraviolet ray generated by the collision between atoms of inert gases activated by electrical field and mercury atoms and passing through the fluorescent material coated on the wall of the lamp.

Each straight lamp 14 comprises a high voltage electrode 14a electrically connected to a high voltage wire (not shown in FIG. 1) and a low voltage electrode 14b electrically connected to a ground wire (not shown in FIG. 1), and the high voltage electrode 14a and the low voltage electrode 14b are respectively disposed on two opposite sides of the display panel. The control circuit comprises an alternating current/direct current adapter (AC/DC adapter, not shown in FIG. 1) for converting an alternating current to a direct current, a DC/AC inverter for converting the direct current to an alternating current with high voltage and frequency to drive the straight lamp 14 of the backlight source 10, and a converter (not shown in FIG. 1) for converting the direct current to an operating current. Each connector 16 is electrically connected to the corresponding high voltage wire and ground wire, so as to provide a high voltage and a low voltage respectively to the high voltage electrode 14a and the low voltage electrode 14b of the straight lamp 14, enabling the straight lamp 14 to discharge and generate a light source by the voltage difference between the high voltage electrode 14a and the low voltage electrode 14b. Generally, the DC/AC inverter comprises a transformer for converting the voltage of direct current.

In order to meet the luminous requirement of the product, numerous straight lamps 14 are employed in the backlight source 10 of the backlight unit according to the prior art. However, the amount of the connector 16 and the transformer employed increases as the amount of the straight lamps 14 employed increases. As a result, the production cost and the consumption in electricity of the backlight unit are apparently increased, therefore making the backlight unit a less competent product. In addition, the backlight source 10 is installed in a small space, such as in the bezel 12, for the purpose of reducing the volume of the product. Since the high voltage electrode 14a and the low voltage electrode 14b of the straight lamp 14 are disposed on opposite sides of the display panel, and the DC/AC inverter is normally disposed on the same side of the display panel as the high voltage electrode 14a, heat generated by the DC/AC inverter and the high voltage electrode 14a during the operation of the backlight unit can hardly be entirely dissipated and is therefore accumulated in the backlight unit, leading to a temperature gradient between the two opposite sides of the display panel. As a result, the display quality of the display panel is seriously flawed, and the product life of the backlight unit is reduced as well.

### SUMMARY OF INVENTION

It is therefore an object of the present invention to provide a backlight source employed in a direct-type backlight unit, so as to prevent a temperature gradient between two opposite sides of a display panel.

According to the claimed invention, the backlight source of the direct-type backlight unit is disposed under the display panel and comprises a plurality of U-shaped lamps parallel arranged. Each of the U-shaped lamp comprises a high voltage electrode and a low voltage electrode, and the high voltage electrodes of the U-shaped lamps are disposed equally on two sides of the display panel.

It is an advantage of the present invention against the prior art that the backlight source revealed in the present invention utilizes the U-shaped lamps instead of the straight lamps in the prior art to achieve a same luminous intensity on the display panel. The quantity of lamps in the backlight unit is reduced, and the quantities of inverters and transformers are relatively reduced as well, preventing abnormal accumulation of heat in the backlight unit during operation and reducing the production cost of the backlight unit. Consequently, the backlight unit 40 turns to be a much more competent product in the market.

These and other objectives of the present invention will no doubt become obvious to those of ordinary skill in the art after reading the following detailed description of the preferred embodiment, which is illustrated in the multiple figures and drawings.

### BRIEF DESCRIPTION OF DRAWINGS

FIG. 1 is a schematic view of a backlight source of a backlight unit according to the prior art.

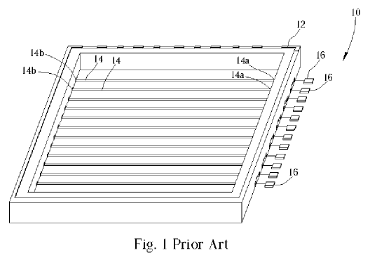

FIG. 2 is the schematic view of a backlight source of a direct-type backlight panel unit according to the present invention.

FIG. 3 is an exploded side view of the backlight unit according to the present invention.

FIG. 4 is the schematic view of a backlight source of a direct-type backlight unit according to a second embodiment of the present invention.

### DETAILED DESCRIPTION

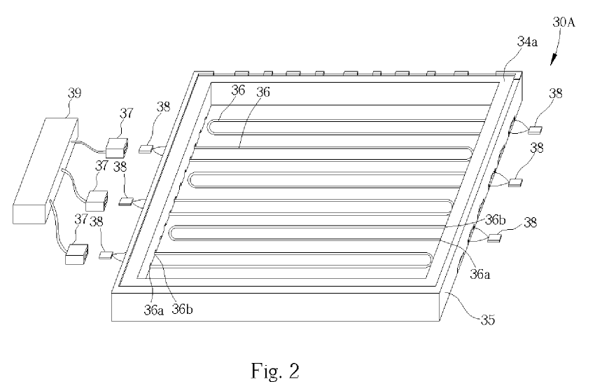

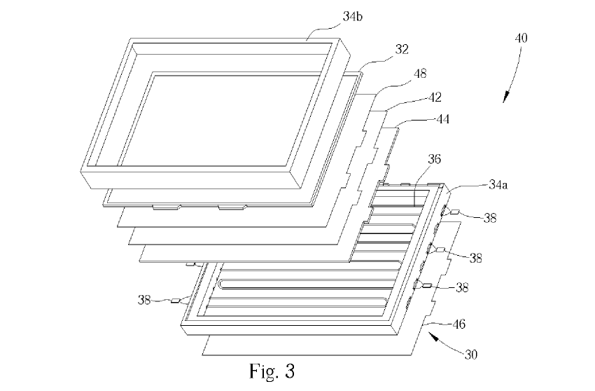

Referring to FIG. 2 and FIG. 3, they are a schematic view of a backlight source 30A of a direct-type backlight panel unit 40, and an exploded side view of the direct-type backlight panel unit 40 in FIG. 2, respectively. As shown in FIG. 2, the backlight source 30A is disposed in a frame 34a under a display panel 32 (only shown in FIG. 3) and is utilized to provide a light source to the display panel 32. The backlight source 30A comprises a plurality of U-shaped lamps 36 parallel arranged in the back bezel 35 for providing a light source to the display panel 32, and the U-shaped lamps 36 alternately face two opposite sides of the display panel 32. Each U-shaped lamp 36 comprises a high voltage electrode 36a and a low voltage electrode 36b, and an outer surface of the U-shaped lamp 36 is adjacent to the outer surface of an adjacent U-shaped lamp 36, as shown in FIG. 3.

Generally, the high voltage electrode 36a tends to generate heat during the operation of the backlight source 30A. Therefore, the high voltage electrodes 36a are disposed equally on two sides of the display panel 32 so as to prevent abnormal accumulation of heat on one side of the display panel 32.

The backlight source 30A further comprises a plurality of control circuits 37 electrically connected to a power supply 39 for providing current to drive the corresponding U-shaped lamp 36. Each connector 38 is connected to a control circuit 37, such as a direct current/alternating current (DC/AC) inverter, a pulse width modulation (PWM) inverter or a series resonant parallel loaded (SPRL) inverter, electrically connected to the high voltage electrode 36a and the low voltage electrode 36b of the corresponding U-shaped lamp 36 for converting direct current to alternating current. Generally, the inverter comprises transformers for converting the voltage of direct current and provides a high voltage and a low voltage respectively to the high voltage electrode 36a and the low voltage electrode 36b of the corresponding U-shaped lamp 36, enabling the U-shaped lamp 36 to discharge and generate the light source by the voltage difference between the high voltage electrode 36a and the low voltage electrode 36b.

As shown in FIG. 3, the direct-type backlight unit 40 further comprises a diffuser 42 disposed between the U-shaped lamp 36 and the display panel 32, a light diffuser plate 44 disposed between the U-shaped lamp 36 and the diffuser 42, a reflecting plate 46 disposed under the U-shaped lamp 36, a housing (not shown in FIG. 3) disposed under the reflecting plate 46 to surround the reflecting plate 46, and a front bezel 34b for engaging with the back bezel 35 to assemble the display panel 32, the diffuser 42, the light diffuser plate 44, the reflecting plate 46 and the backlight source 30A. The reflecting plate 46 is employed to upwardly reflect the light source generated by the U-shaped lamp 36 to the light diffuser plate 44 and thereby increase the light use efficiency of the direct-type backlight unit 40. The light diffuser plate 44 is utilized to scatter the light source to the diffuser 42, and the diffuser 42 is utilized to further scatter the light source to provide the display panel 32 with an even luminous intensity. Optionally, at least one prism 48 is disposed on the diffuser 42 to reduce the difference of the luminous intensities on the display panel 32 in advance.

In the preferred embodiment of the present invention, the U-shaped lamps 36 are cold cathode fluorescent lamps (CCFLs), and the outer surface of each U-shaped lamp 36 is adjacent to the outer surface of an adjacent U-shaped lamp 36. The diffuser 42 is composed of either polyethylene terephthalate (PET) or polycarbonate (PC), the light diffuser plate 44 is composed of either acrylic or PC, and the reflecting plate 46 is composed of either aluminum, alloy, foamed PET or PC resin.

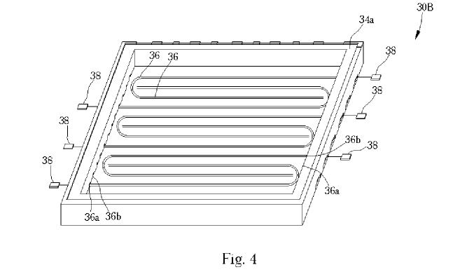

Referring to FIG. 4, it is the schematic view of a backlight source 30B of a direct-type backlight unit according to the second embodiment of the present invention. As shown in FIG. 4, the composition of the backlight source 30B is similar to that of the backlight source 30A in FIG. 2. The only difference between the backlight source 30A in FIG. 2 and the backlight source 30B is that the U-shaped lamps 36 in FIG. 4 are more closely arranged than the U-shaped lamps 36 in FIG. 2. As shown in FIG. 4, the inner surface of each U-shaped lamp 36 is adjacent to the inner surface of an adjacent U-shaped lamp 36, assuring a much more even luminous intensity of the light source on the display panel 32. As shown in FIG. 4, the U-shaped lamps 36 alternately face two opposite sides of the display panel 32. Alternatively, the U-shaped lamps 36 can be arranged in a different manner based on product requirement on the premises that an even luminous intensity of the light source is assured and the abnormal accumulation of heat in the direct-type backlight unit 40 during operation is prevented.

In comparison with the backlight source 10 in the prior art, the backlight sources 30A and 30B provided in the present invention utilizes the U-shaped lamps 36 alternately arranged instead of the straight lamps 14 in the prior art to achieve a same luminous intensity on the display panel 32. As a result, the quantity of lamps in the backlight unit 40 is reduced. Relatively, the quantities of inverters and transformers are reduced as well, preventing abnormal accumulation of heat in the backlight unit 40 during operation and reducing the production cost of the backlight unit 40. Consequently, the backlight unit 40 turns to be a much more competent product in the market.

Those skilled in the art will readily observe that numerous modifications and alterations of the device may be made while retaining the teachings of the invention. Accordingly, the above disclosure should be construed as limited only by the metes and bound of the appended claims.

1. A backlight source disposed under a display panel, the backlight source comprising a plurality of parallel U-shaped lamps or call C-shaped lamps, each of the U-shaped or C-shaped lamps having an inner surface and an outer surface and comprising a high voltage electrode and a low voltage electrode, the high voltage electrodes being disposed equally on two sides of the display panel.

2. The backlight source of claim 1 wherein the backlight source is installed in a direct-type backlight panel unit.

3. The backlight source of claim 2 wherein the direct-type backlight unit comprises a diffuser disposed between the display panel and the plurality of the U-shaped lamps for scattering a light source generated by the plurality of the U-shaped lamps to the display panel, a light diffuser plate disposed between the diffuser and the plurality of the U-shaped lamps for transmitting the light source to the diffuser, and a reflecting plate disposed under the plurality of the U-shaped lamps for reflecting the light source to the light diffuser plate.

4. The backlight source of claim 3 wherein the direct-type backlight panel unit further comprises a housing disposed under the reflecting plate for surrounding the reflecting plate, and a bezel for assembling the display panel and the backlight source.

5. The backlight source of claim 1 wherein the U-shaped lamp is a cold cathode fluorescent lamp (CCFL).

6. The backlight source of claim 1 wherein the U-shaped lamps alternately face two opposite sides of the display panel.

7. The backlight source of claim 6 wherein the inner surface of the U-shaped lamp is adjacent to the inner surface of an adjacent U-shaped lamp.

8. The backlight source of claim 6 wherein the outer surface of the U-shaped lamp is adjacent to the outer surface of an adjacent U-shaped lamp.

9. The backlight source of claim 1 wherein the backlight source further comprises a power supply for providing current and a control circuit electrically connected to the power supply for driving the backlight source.

10. The backlight source of claim 9 wherein the control circuit comprises at least one inverter electrically connected to the high voltage electrode and the low voltage electrode of the corresponding U-shaped lamp.

11. The backlight source of claim 10 wherein the inverter comprises a direct current/alternating current (DC/AC) inverter, a pulse width modulation (PWM) inverter or a series resonant parallel loaded (SPRL) inverter.
